(19) United States
(12) Patent Application Publication
(10) Pub. No.: US 2008/0223866 A1
(43) Pub. Date: Sep. 18, 2008

(54) BAND-TYPE DISPENSER FOR WRAP FILM

(76) Inventor: Ching-Hsiang Wang, Taipei (TW)

Correspondence Address: Ching-Hsiang WANG, 235 Chung - Ho Box 8-24, Taipei - R. O. C., TW

(21) Appl. No.: 11/836,808

(22) Filed: Aug. 10, 2007

Related U.S. Application Data
(63) Continuation-in-part of application No. 11/687,654, filed on Mar. 18, 2007, now Pat. No. 7,395,640.

(51) Int. Cl. G07F 11/68

(52) U.S. Cl. 221/30

(57) ABSTRACT

A band-type dispenser for wrap film includes a base, an endless band device, and a cutter unit. The base has a chamber in its interior, and a positioning bracket is respectively fixed at two sides of the chamber for supporting a roll of wrap film. The endless band device is disposed in the base and has at least one endless band for moving the wrap film. The cutter unit is positioned in front of the endless band device for cutting wrap film. The dispenser is automatically operated, with a cut piece of the wrap film kept flat and smooth, so a user can use it with safety and convenience.

The present invention is a continuation in part (CIP) of U.S. patent Series No. 11/687,654 which is assigned and invented by the applicant of the present invention. Thererfore, the contents of U.S. patent Series No. 11/687,654 is incorporated into the present invention as a part of the specification of the present invention.

### BACKGROUND OF THE INVENTION

1. Field of the Invention

This invention relates to a band-type dispenser for wrap film, particularly to one provided with a base formed with a chamber, a positioning bracket respectively fixed at two sides of the chamber for supporting a roll of wrap film thereon, an endless band device installed in the base and having at least one endless band electrically moved to shift out wrap film, a cutter unit positioned in front of the endless band for cutting off the wrap film. It can automatically move and cut the wrap film, keeping a piece of cut wrap film flat and smooth, without entangling, enabling a user to use it conveniently and safely.

2. Description of the Prior Art

Nowadays, wrap film is indispensable in general households, used for wrapping food or covering a container, such as bowls, saucers, cups, etc. preventing floating dirt in the air from smearing food or flies or insects from polluting food. Moreover, it can prevent food from dehydrating when food wrapped with wrap film is stored in a refrigerator, or it can seal food for cooking in a microwave cooker, and hold cooked food.

A conventional wrap film as shown in FIG. 1, a roll of conventional wrap film 10 is placed in an elongate case 11, which has a swingable cover 12, with an elongate exit formed between the swingable cover 12 and the case 11, and a saw-teeth blade 13 fixed at a side edge of the exit. In using, the wrap film 10 is pulled out from its roll, then the swingable cover 12 is pressed with one hand with an outer end of the wrap film 10 held with another hand. Then the wrap film 10 is pulled in such a direction that the wrap film 10 may be cut off by the blade 13. In traditional handling of cutting the wrap film 10, a user often presses one end of the swingable cover 12, instead of pressing and moving it toward the body 11, so the wrap film is not easily cut off owing to uneven pressing, causing entangling of the wrap film. Then the conventional wrap film is sometimes troublesome to use.

In addition, the saw-teeth blade 13 is fixed outside of the case 11, so a user's hand may be hurt in cutting operation by the blade 13. Therefore, the conventional wrap film is often not safe for using.

### SUMMARY OF THE INVENTION

The main objective of the invention is to offer a band-type dispenser for wrap film, with a roll of wrap film possible to be quickly replaced with a new one.

Another objective of the invention is to offer a band-type dispenser for wrap film to cut electrically the length of wrap film needed and keep the cut piece of the wrap film flat and smooth, so this dispenser is safe and convenient to use.

One primary feature of the present invention is that a base with a chamber, and a positioning bracket respectively fixed at two sides of the chamber for supporting a roll of wrap film thereon; an endless band device arranged in the base and having at least one endless band for moving the wrap film out; a cutter unit disposed in front of the endless band device for cutting the wrap film.

Another feature of the invention is that at least one film separating guider is provided beside the at least one endless band for separating the wrap film from the surface of the endless band.

### BRIEF DESCRIPTION OF DRAWINGS

This invention will be better understood by referring to the accompanying drawings, wherein:

FIG. 1 is a perspective view of a conventional wrap film being used;

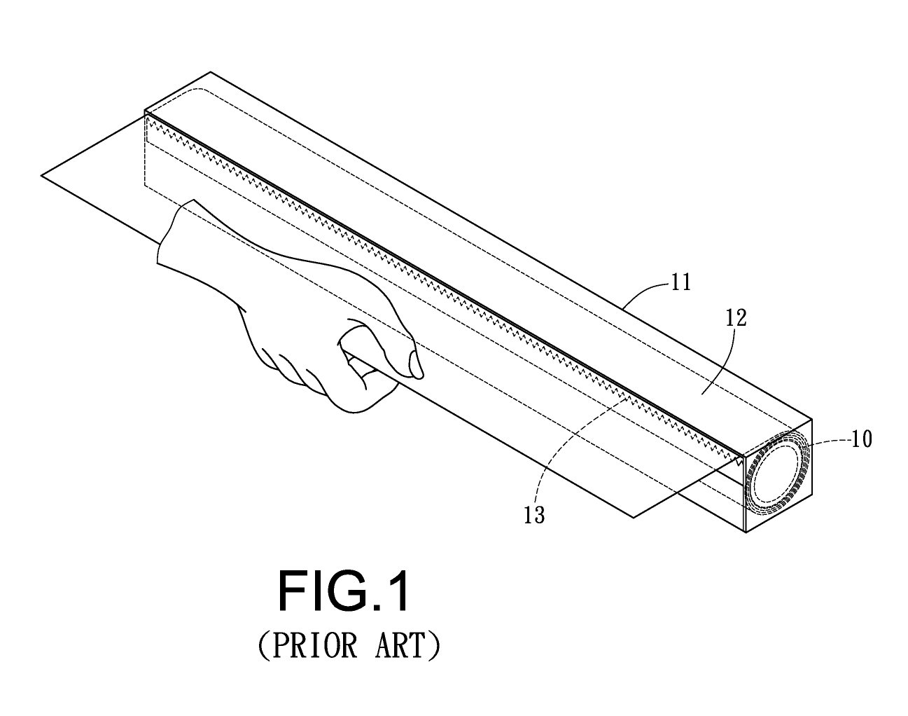

FIG. 2 is a perspective view of a band-type dispenser for wrap film in the present invention;

FIG. 3 is a side cross-sectional view of the band-type dispenser for wrap film in the present invention;

FIG. 4 is a perspective view of a drive unit and a cutter unit combined in the band-type dispenser for wrap film in the present invention;

FIG. 5 is a perspective view of the band-type dispenser for wrap film in the present invention; and,

FIG. 6 is a perspective view of the band-type dispenser for wrap film being used in the present invention.

### DETAILED DESCRIPTION OF THE PREFERRED EMBODIMENT

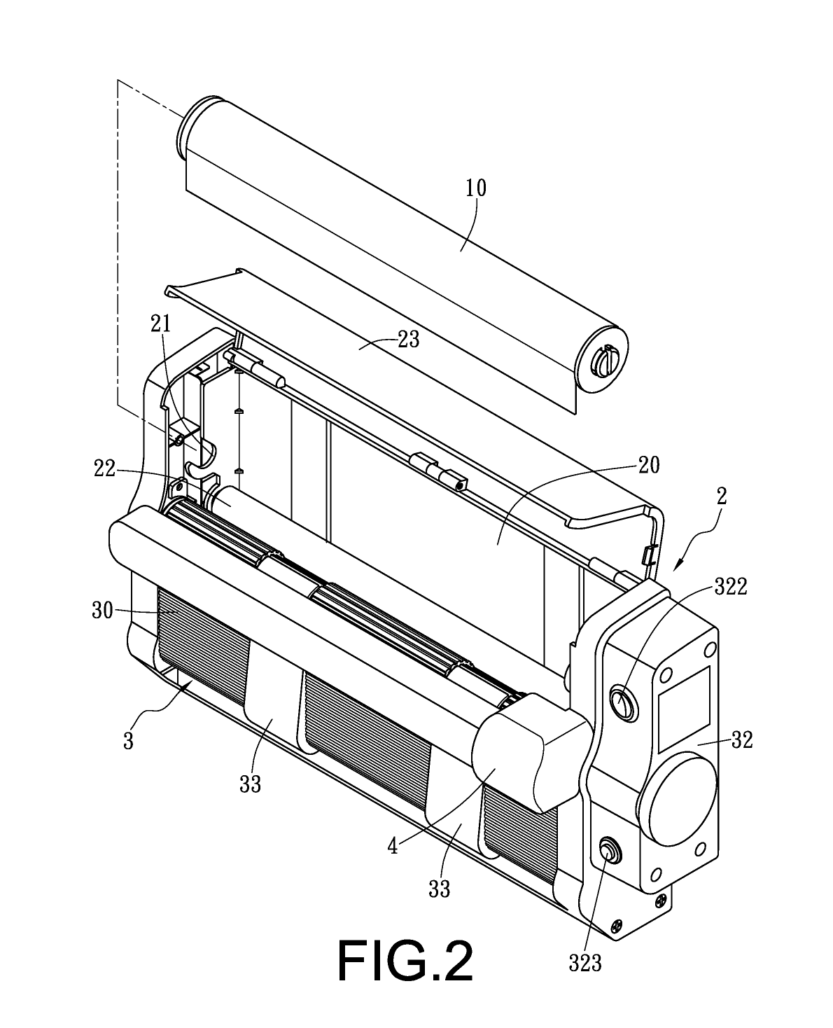

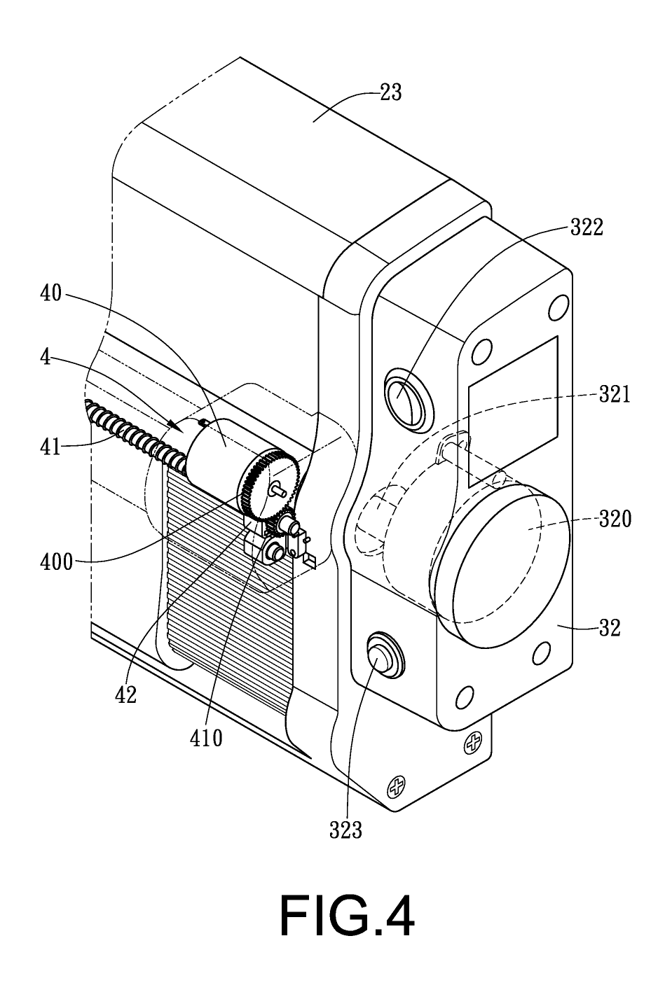

A preferred embodiment of a band-type dispenser for wrap film in the present invention, as shown in FIGS. 2-5, includes a base 2, an endless band device 3, and a cutter unit 4 as main components combined together.

The base 2 is provided with a chamber 20 in its interior, a positioning bracket 21 respectively fixed at two sides of the chamber 20 for supporting a roll of wrap film 10, an auxiliary rotary rod 22 set in the chamber 20 for moving supplementarily the wrap film 10, a swingable cover 23 swingably connected to the base 2 to close on or open an upper side of the base 2.

The endless band device 3 is arranged in the base 2, composed of at least one endless band 30 with plural long straight grooves 300 closely spaced apart, a pair of rotatable shafts 31 spaced apart with a proper distance for the at least one endless band 30 to rest on to be moved by the rotatable shafts 31, a driving unit 32 combined with one of the rotatable shafts 31 and consisting of a synchronous motor 320, a changeover switch 322 and a press button 323. The motor 320 has a shaft 321 to rotate the relative rotatable shaft 31 for moving the at least one endless band 30 to circulate around the two rotatable shafts 31. Further at least one film separating guider 33 is provided just beside the at least one endless band 30 and has a curvy bottom slightly protruding than the outer surface of the at least one endless band 30 so that the at least one film separating guider 33 can guide the wrap film 10 to separate from the outer surface of the endless band 30 for a user to grip easily the outer end of the wrap film 10.

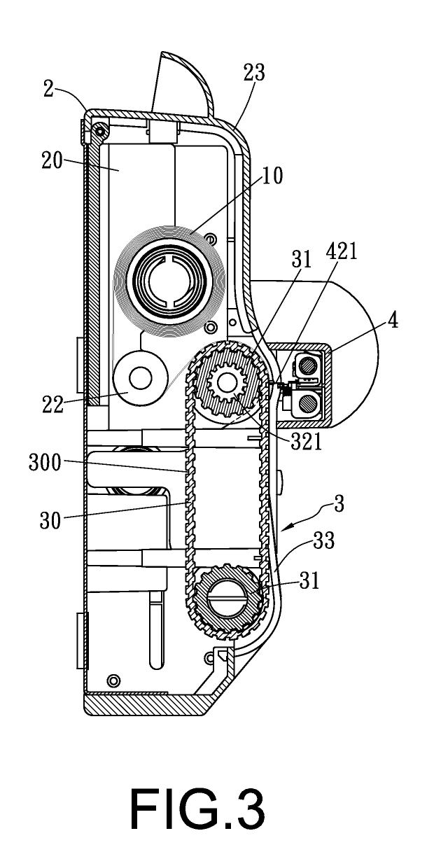

The cutter unit 4 is deposited in front of the endless band device 3, composed of a drive motor 40 connected to the press button 323 of the driving unit 32 via a power line to be turned on and off, a drive gear 400 positioned at an outer side of the drive motor 40, an elongate threaded rod 41 having one end fixed with a pinion 410 engaging with the drive gear 400, a blade fixer 42 possible to reciprocate along the threads of the threaded rod 41, a blade 421 fixed on one side of the blade fixer 42 and having its edge facing closely to the outer surface of the endless band 30, as shown in FIG. 3.

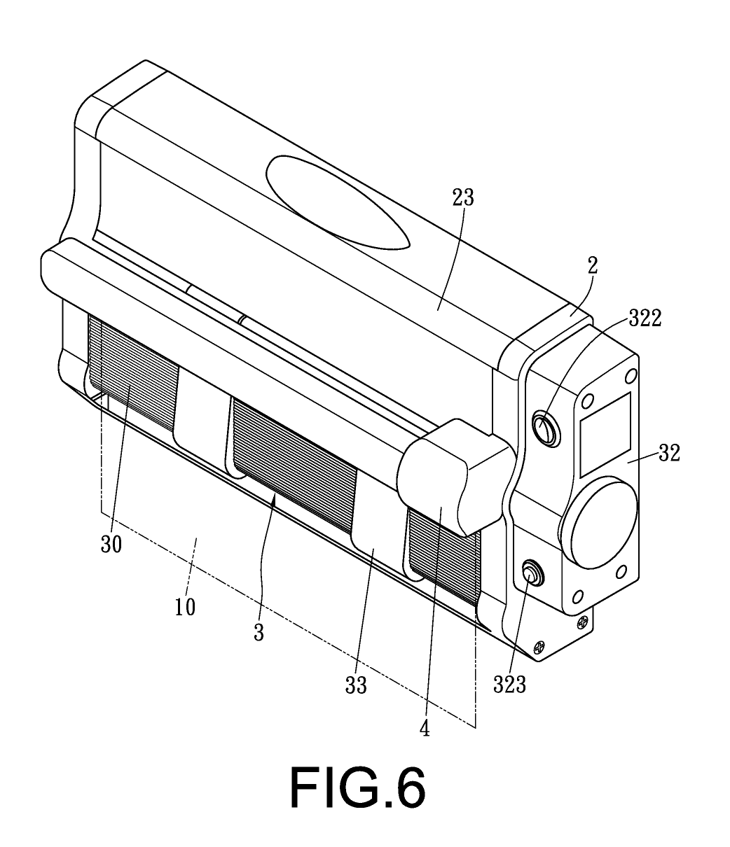

Next, in using, referring to FIGS. 2, 3, 5 and 6, firstly, put a roll of wrap film 10 in the chamber 20 of the base 2 and hang it on the two brackets 21. Secondly, pull the outer end of the wrap film 10 around the auxiliary rotary rod 22 to make it placed on the outer surface of the at least one endless band 3. Thirdly, press the changeover switch 322 of the driving unit 32 to turn on the power, and then press the press button 323 to start the synchronous motor 320 to rotate the shaft 321 to drive the rotatable shaft 31 to move the endless band 30 to circulate around the two rotatable shafts 31 so as to carry the wrap film 10 stuck on the at least one endless band 30, by which the wrap film 10 may move gradually along on the at least one film separating guider 33 and separate from the surface of the at least one endless band 30. Finally, when the wrap film 10 is moved out to a needed length, release the press button 323 to pause the synchronous motor 320 and at the same time to start the drive motor 40 of the cutter unit 4 to drive the drive gear 400 to rotate the pinion 410 of the threaded rod 41 to force the threaded rod 41 to shift the blade fixer 42 along the threads of the threaded rod 41 towards the wrap film 10 on the at least one endless band 30 so that the blade 421 may cut lengthwise the wrap film 10, moving in one of the straight grooves 300 without cutting the at least one endless band 30 itself. The cut piece of wrap film 10 can be neat and smooth as shown in FIG. 6. In this way, the band-type dispenser for wrap film in the invention is safe and automatically used, possible to be placed on a table or hung on a wall for use.

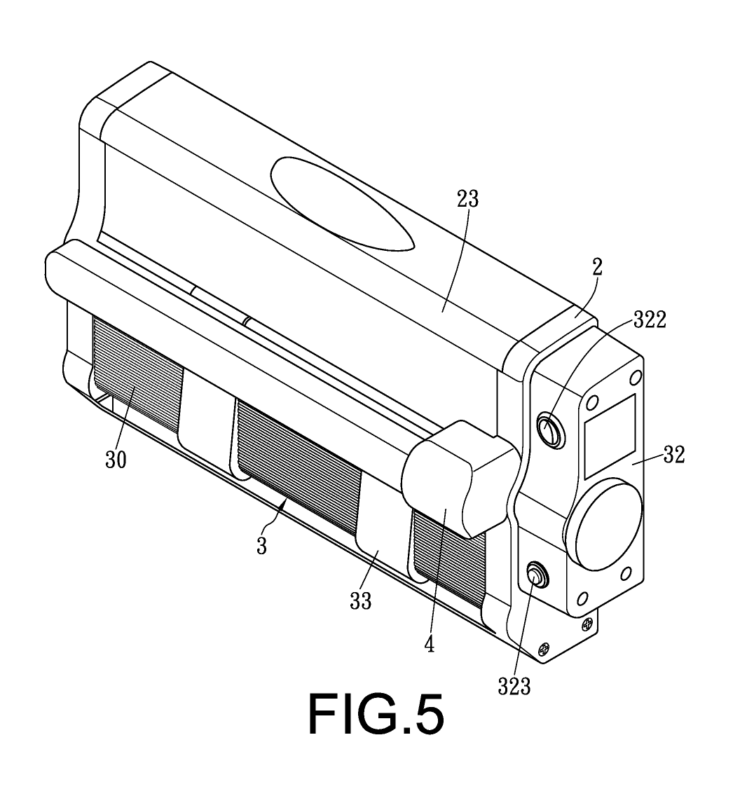

If the roll of wrap film 10 is needed to be replaced with a new one, as shown in FIGS. 2 and 5, swing up the swingable cover 23, and take off the old roll of wrap film 10 and put on a new one on the brackets 21, with the outer end of the new roll of wrap film 10 pulled to extend around the auxiliary rotary rod 22 and placed on the at least one endless band 30, thus finishing changing operation.

While the preferred embodiment of the invention has been described above, it will be recognized and understood that various modifications may be made therein and the appended claims are intended to cover all such modifications that may fall within the spirit and scope of the invention.

What is claimed is:

1. A band-type dispenser for wrap film, said dispenser comprising:
a base provided with a chamber in its interior, a positioning bracket respectively fixed at two sides of said chamber for supporting a roll of wrap film thereon;
an endless band device arranged in said base and having at least one endless band for moving said wrap film out; and,
a cutter unit disposed in front of said endless band device for cutting said wrap film.

2. The band-type dispenser for wrap film as claimed in claim 1, wherein an auxiliary rotary rod is provided in said base.

3. The band-type dispenser for wrap film as claimed in claim 1, wherein a swingable cover is closed on an upper side of said base.

4. The band-type dispenser for wrap film as claimed in claim 1, wherein a driving unit is fixed at a side of said endless band device for moving said at least one endless band.

5. The band-type dispenser for wrap film as claimed in claim 4, wherein said drive unit is composed of a changeover switch and a press button.

6. The band-type dispenser for wrap film as claimed in claim 1, wherein at least one film separating guider is provided beside said at least one endless band.

7. The band-type dispenser for wrap film as claimed in claim 1, wherein said at least one endless band is provided with plural straight grooves closely spaced apart in its outer surface.
